(19) United States
(12) Patent Application Publication
(10) Pub. No.: US 2026/0172737 A1
(43) Pub. Date: Jun. 18, 2026

(54) EARPHONE AND EARPHONE SYSTEM

(71) Applicant: Beijing Zitiao Network Technology Co., Ltd., Beijing (CN)

(72) Inventor: Shudong LIU, Beijing (CN)

(21) Appl. No.: 19/295,972

(22) Filed: Aug. 11, 2025

(30) Foreign Application Priority Data
Dec. 13, 2024 (CN) 202411849170.7

(51) Int. Cl. H04R 1/10

(52) U.S. Cl. CPC H04R 1/1066; H04R 1/1025; H04R 1/1041; H04R 1/105; H04R 1/1075

(57) ABSTRACT

The present disclosure relates to the field of wearable device technology, and in particular to an earphone and an earphone system, wherein the earphone includes: a sound-emitting portion configured to be disposed on a front side of an ear; a body portion configured to be disposed on a rear side of the ear; and a transition connecting portion, two ends of the transition connecting portion being respectively connected with the sound-emitting portion and the body portion, wherein the sound-emitting portion is detachably connected with the transition connecting portion.

### CROSS-REFERENCE TO RELATED APPLICATIONS

The present disclosure is based on and claims priority to Chinese Patent Application No. 202411849170.7, and filed on Dec. 13, 2024, the entire disclosure of the Chinese Patent Application is incorporated herein by reference in its entirety.

### TECHNICAL FIELD

The present application relates to the field of wearable device technology, and in particular to an earphone and an earphone system.

### BACKGROUND

Common earphones include an ear-clip type of earphone and an ear-hook type of earphone. The ear-clip type of earphone is fixed on the ear through a clamping force of an ear clip, and the ear-hook type of earphone is worn on the ear through multi-point support of an ear hook.

### SUMMARY

In view of the above problems, the present disclosure proposes an earphone and an earphone system, which can realize multiple earphone forms and acoustic functions, and adapt to users'ears of different shapes and sizes.

A first aspect of the present disclosure provides an earphone, including: a sound-emitting portion configured to emit sounds and disposed on a front side of an ear; a body portion configured to be disposed on a rear side of the ear; and a transition connecting portion, two ends of the transition connecting portion being respectively connected with the sound-emitting portion and the body portion, wherein the sound-emitting portion is detachably connected with the transition connecting portion.

In the earphone of the present disclosure, the sound-emitting portion and the transition connecting portion are detachably connected, so that a user can cause the sound-emitting portion and the transition connecting portion to flexibly switch between a connected state and a disconnected state according to factors such as wearing comfort, wearing habit, earphone working condition, etc., thereby adjusting wearing postures of the earphone, achieving different acoustic effects, meeting usage requirements to the greatest extent, and improving usage experiences. Furthermore, the earphone has a variety of wearing postures which can be flexibly switched, can adapt to user's ears of different shapes and sizes, mitigating a problem that the earphone wearing acoustic effects are inconsistent due to different shapes and sizes of ears, and the earphone having a variety of wearing postures is conducive to reduce the user's usage cost.

In some embodiments, the sound-emitting portion includes a first power supply device and a power-consuming component, the power-consuming component including a speaker unit, a microphone unit, and an electric control unit, wherein the electric control unit is respectively connected with the speaker unit, the microphone unit, and the first power supply device.

In some embodiments, the electric control unit includes: a power-receiving structure; the body portion includes a second power supply device, wherein one end of the transition connecting portion connected with the sound-emitting portion is provided with a power-feeding structure electrically connected with the power-receiving structure, when the sound-emitting portion is connected with the transition connecting portion, the power-feeding structure is connected with the power-receiving structure.

In some embodiments, an endurance of the first power supply device is smaller than an endurance of the second power supply device.

In some embodiments, the first power supply device is further electrically connected with the power-receiving structure, so as to be charged when the power-receiving structure is connected with the power-feeding structure.

In some embodiments, when the sound-emitting portion is connected with the transition connecting portion, the second power supply device supplies power to the power-consuming component.

In some embodiments, when the power-receiving structure is connected with the power-feeding structure, at least one of the second power supply device and the first power supply device supplies power to the power-consuming component.

In some embodiments, the sound-emitting portion further includes: a first housing including a sound-emitting housing, wherein at least the speaker unit and the microphone unit are disposed in an inner cavity of the sound-emitting housing.

In some embodiments, the first housing further includes an electric control housing, wherein the electric control housing is connected with the sound-emitting housing, wherein at least the electric control unit is disposed in the electric control housing.

In some embodiments, the electric control housing is arranged at an angle to the sound-emitting housing.

In some embodiments, when the sound-emitting portion is connected with the transition connecting portion, at least part of a structure of the first housing is mated with the transition connecting portion.

In some embodiments, the electric control housing is mated with the transition connecting portion, the sound-emitting housing being located at one end of the electric control housing.

In some embodiments, the at least part of the structure of the first housing has a mating surface, wherein a part of a surface of the transition connecting portion is formed into a mating cooperation surface, the mating surface is adapted to abut with the mating cooperation surface, and the mating surface is formed into a plane or a curved surface.

In some embodiments, when the sound-emitting portion is disconnected from the transition connecting portion, the sound-emitting housing is adapted to be arranged to abut with an ear canal opening, the electric control housing being adapted to be sandwiched between an tragus and an antitragus.

In some embodiments, the sound-emitting portion and the transition connecting portion are in magnetic attachment or snap-fit.

In some embodiments, the transition connecting portion is adapted to be suspended on an upper side of the ear; or the transition connecting portion is adapted to apply a pre-acting force to the sound-emitting portion and the body portion so that the sound-emitting portion and the body portion clamp the ear together.

A second aspect of the present disclosure proposes an earphone system, which includes: an earphone box, having an accommodation cavity that is openable and closable; and an earphone in the above first aspect, wherein the earphone is removably disposed in the accommodation cavity, wherein the earphone box is at least configured to charge the earphone.

The earphone system of the present disclosure has the above earphone disposed therein, and due to the earphone having a variety of wearing postures, can realize multiple acoustic effects, further improve the user's usage experience.

### BRIEF DESCRIPTION OF THE DRAWINGS

The drawings herein are incorporated into and constitute a part of this specification, illustrating embodiments conforming to the present disclosure, and serve to explain the principles of the present disclosure together with the description.

FIG. 1 is a schematic diagram of an earphone according to some embodiments of the present disclosure when the sound-emitting portion and the transition connecting portion are in a connected state;

FIG. 2 is a schematic diagram of the earphone shown in FIG. 1 when the sound-emitting portion and the transition connecting portion are in a disconnected state;

FIG. 3 is a schematic diagram of wearing the earphone shown in FIG. 1;

FIG. 4 is a schematic diagram of wearing the earphone shown in FIG. 2;

FIG. 5 is a schematic diagram of an earphone according to other embodiments of the present disclosure when the sound-emitting portion and the transition connecting portion are in a connected state;

FIG. 6 is a schematic diagram of the earphone shown in FIG. 5 when the sound-emitting portion and the transition connecting portion are in a disconnected state;

FIG. 7 is a schematic diagram of wearing the earphone shown in FIG. 5;

FIG. 8 is a schematic diagram of wearing the earphone shown in FIG. 6;

FIG. 9 is a schematic diagram of an earphone according to still other embodiments of the present disclosure when the sound-emitting portion and the transition connecting portion are in a connected state; and

FIG. 10 is a schematic diagram of the earphone shown in FIG. 9 when the sound-emitting portion and the transition connecting portion are in a disconnected state.

### REFERENCE NUMERALS

100—earphone;
10—sound-emitting portion;
101—first housing; 102—sound-emitting housing; 103—electric control housing;
20—body portion;
30—transition connecting portion;
301—mating cooperation surface; 302—balance portion; 303—power-feeding structure;
200—ear;
201—concha cavity; 202—tragus; 203—antitragus.

Through the above drawings, explicit embodiments of the present disclosure have been shown, which will be described in more detail in the following. These drawings and textual descriptions are not intended to limit the scope of the concept of the present disclosure in any way, but rather to illustrate the concept of the present disclosure for those skilled in the art through reference to specific embodiments.

### DETAILED DESCRIPTION

Exemplary embodiments will be described in detail hereinafter, examples thereof being illustrated in the accompanying drawings. The following description involves the accompanying drawings, unless otherwise indicated, same numbers in different drawings indicate same or similar elements. The implementation described in the following exemplary embodiments do not represent all implementations consistent with the present disclosure. On the contrary, they are merely examples of apparatuses and methods consistent with some aspects of the present disclosure as detailed in the appended claims.

Common earphones include an ear-clip type of earphone and an ear-hook type of earphone. The ear-clip type of earphone is fixed on the ear through a clamping force of an ear clip, and the ear-hook type of earphone is worn on the ear through multi-point support of an ear hook. However, the above two types of earphones have relatively limited wearing postures and cannot implement accurate posture adjustment according to user requirements, which makes it difficult to adapt to users'ears of different shapes and sizes, and also fails to realize switching between more earphone forms and functions.

In view of this, the present disclosure proposes an earphone and an earphone system, in which the sound-emitting portion and the transition connecting portion are detachably connected, so that a user can cause the sound-emitting portion and the transition connecting portion to flexibly switch between a connected state and a disconnected state according to factors such as wearing comfort, wearing habit, earphone working condition, etc., thereby adjusting wearing postures of the earphone, achieving different acoustic effects, meeting usage requirements to the greatest extent, and improving usage experiences. Furthermore, the earphone has a variety of wearing postures which can be flexibly switched, can adapt to user's ears of different shapes and sizes, mitigating a problem that the earphone wearing acoustic effects are inconsistent due to different shapes and sizes of ears.

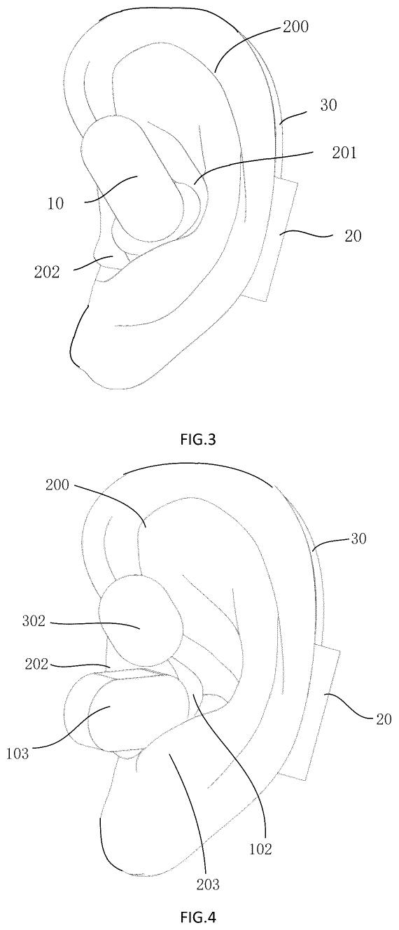

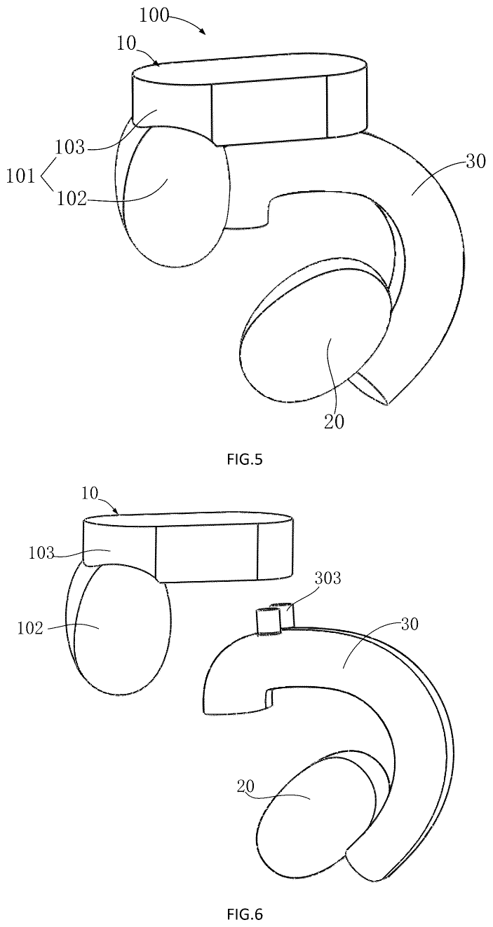

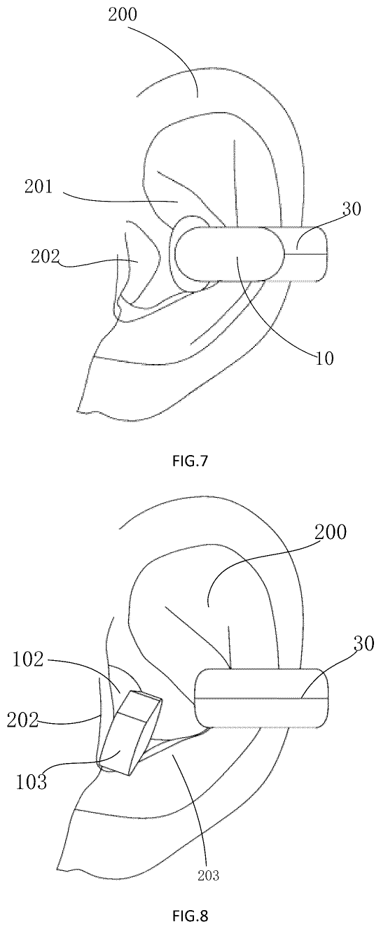

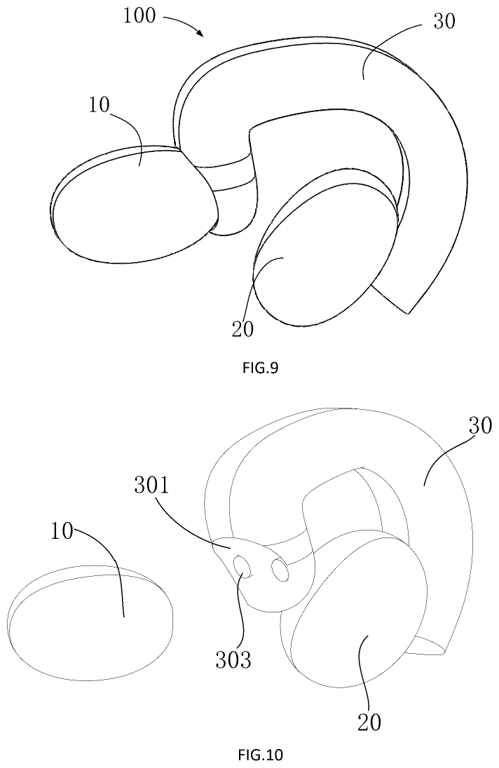

In conjunction with FIGS. 1-10, an earphone 100 according to an embodiment of the present disclosure may be an ear-hook type of earphone, an ear-clip type of earphone, or other types of earphones. The earphone 100 of the embodiment includes: a sound-emitting portion 10, a body portion 20, and a transitional connecting portion 30.

The sound-emitting portion 10 serves as a sound-emitting region of the earphone 100, and is mainly used for sound emitting, taking the earphone 100 being in a worn state as an example, the sound-emitting portion 10 is located at a front side of the ear 200, so as to make the sound-emitting portion 10 as close as possible to the ear canal opening of the wearer of the earphone 100, which is conducive to sound transmission and ear reception of sound.

The sound-emitting portion 10 may include a speaker unit (not shown) and a microphone unit (not shown), where the speaker unit is mainly used for converting electrical signals into sound signals, so as to facilitate the wearer of the earphone 100 receiving sounds; the microphone unit may be used for capturing sounds emitted by the wearer of the earphone 100, and converting sound signals into electrical signals, so as to facilitate sound processing and transmission to other devices.

The body portion 20 may include a power supply device (for example, a second power supply device mentioned below) and other functional components. In the worn state, the body portion 20 is disposed at rear side of the ear 200, on one hand, it is conducive to avoiding the body portion 20 affecting the layout of the sound-emitting portion 10 relative to the human face and the ear 200, on the other hand, the body portion 20 and the sound-emitting portion 10 cooperate with each other from the front and rear sides of the ear 200, which facilitates the wearer wearing the earphone 100 more stably, and can also avoid affecting the aesthetics during wearing.

Two ends of the transition connecting portion 30 are connected to the sound-emitting portion 10 and the body portion 20 respectively. The sound-emitting portion 10 and the transition connecting portion 30 are detachably connected, that is, the sound-emitting portion 10 and the transition connecting portion 30 can be switched between a connected state and a disconnected state. In the connected state, the sound-emitting portion 10, the body portion 20, and the transition connecting portion 30 cooperate with each other, so as to make the earphone 100 be worn stably on the ear, in this state, the earphone 100 can be used as an open-type earphone 100; in the disconnected state, the sound-emitting portion 10 can be worn on the ear individually without relying on the cooperation of the transition connecting portion 30 and the body portion 20, correspondingly, the combination of the transition connecting portion 30 and the body portion 20 can also be worn on the ear without relying on the cooperation of the sound-emitting portion 10, in this state, the sound-emitting portion 10 can be used as an in-ear type earphone 100.

It can be understood that, in the disconnected state, either of the combination of the transition connecting portion 30 and the body portion 20, or the sound-emitting portion 10 can be worn on the ear individually, or both can be worn on the ear simultaneously and not connected to each other.

For example, taking the ear-clip type of earphone as an example, the earphone 100 clamps and worn on the ear 200 in a state where the sound-emitting portion 10 and the transition connecting portion 30 are connected, which, after a certain period of time, would easily cause the ear 200 to be painfully pinched, or in a noisy environment, environmental noise interferes with the sound of the earphone 100, at this time, it may disconnect the sound-emitting portion 10 and the transition connecting portion 30, and then adjust the wearing direction and angle of the sound-emitting portion 10, and insert the sound-emitting portion 10 into a position of the ear canal opening behind the tragus 202, which is equivalent to converting the ear-clip type of earphone into an in-ear type of earphone, thereby realizing the switching between different acoustic effects of the ear-clip type of earphone; when the power of the sound-emitting portion 10 is sufficient after the sound-emitting portion 10 works alone for a period of time or there is a need to connect the sound-emitting portion 10 and the transitional connecting portion 30, the user can reconnect the sound-emitting portion 10 and the transitional connecting portion 30 again. Thus, the same earphone 100 can have a variety of wearing forms, enriching the user's wearing manners and improving the usage experience.

In the earphone 100 according to the embodiments of the present disclosure, the sound-emitting portion 10 and the transition connecting portion 30 are detachably connected, so that a user can cause the sound-emitting portion 10 and the transition connecting portion 30 to flexibly switch between a connected state and a disconnected state according to factors such as wearing comfort, wearing habit, earphone working condition, etc., thereby adjusting wearing postures of the earphone 100, achieving different acoustic effects, meeting usage requirements to the greatest extent and improving the usage experience. Furthermore, the earphone 100 has a variety of wearing postures which can be flexibly switched, can adapt to user's ears 200 of different shapes and sizes, mitigating a problem that the wearing acoustic effects of the earphone 100 are inconsistent due to different shapes and sizes of ears 200, and the earphone 100 having a variety of wearing postures is conducive to reduce the user's usage cost.

In some embodiments, the sound-emitting portion 10 may include a power-consuming component and a first power supply device, where the power-consuming component may include the speaker unit, the microphone unit, and the electric control unit. The electric control unit is connected to the speaker unit, the microphone unit, and the first power supply device respectively.

The first power supply device may be a battery, and the first power supply device can store a certain capacity of electricity, in the state in which the sound-emitting portion 10 is disconnected from the transition connecting portion 30 and the body portion 20, the first power supply device can power the speaker unit, the microphone unit, and the electric control unit, so as to ensure normal operation of the speaker unit and the microphone unit.

The electric control unit may include a circuit board, a processor, a communication module, etc. Exemplarily, the circuit board may be a flexible printed circuit (FPC), a printed circuit board (PCB), etc., and the communication module may be a Bluetooth module, a WiFi module, a cellular module, etc. The electric control unit may be used for realizing circuit control, controlling a working state of the speaker unit, such as regulating volume, controlling turn-on and turn-off of the speaker unit, and controlling a working state of the microphone unit, and can also perform external communication.

In some embodiments, the electric control unit may include a power-receiving structure. The body portion 20 may include a second power supply device, and the second power supply device may be a battery. The first power supply device and the second power supply device may be identical or different.

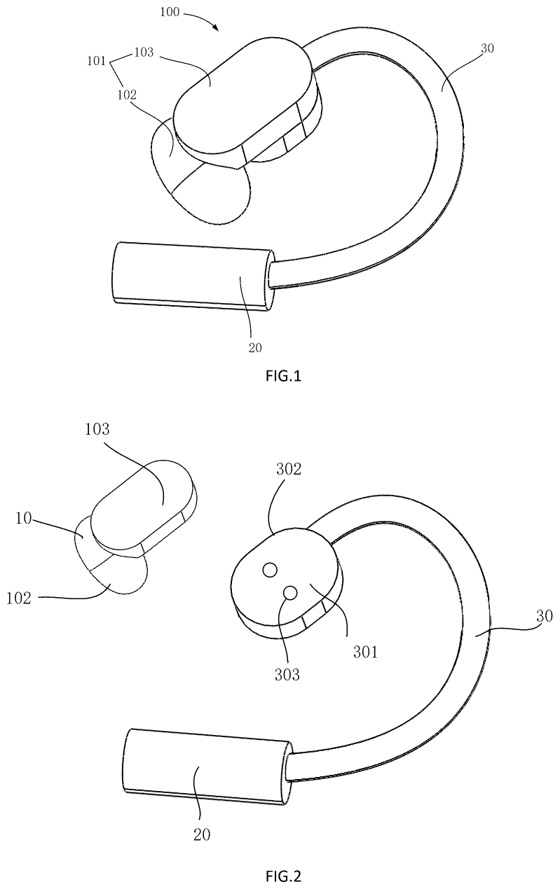

In conjunction with FIGS. 2, 6, and 10, one end of the transition connecting portion 30 that is connected to the sound-emitting portion 10, i.e., one end of the transition connecting portion 30 extending to a front side of the ear, is provided with a power-feeding structure 303. Optionally, the power-receiving structure may be a PIN needle, and the power-feeding structure 303 may be a power-feeding hole corresponding to the PIN needle; or, the power-receiving structure may be a power-feeding hole, and the power-feeding structure 303 may be a power-feeding hole corresponding to the power-feeding hole.

The power-feeding structure 303 is suitable for being electrically connected and cooperated with the power-receiving structure.

Among them, when the sound-emitting portion 10 is connected to the transition connecting portion 30, the power-feeding structure 303 is connected to the power-receiving structure, therefore, under the state in which the sound-emitting portion 10 is connected to the transition connecting portion 30, the second power supply device can directly power the power-consuming components of the sound-emitting portion 10, such as the speaker unit, the microphone unit, and the electric control unit.

In some possible embodiments, the endurance of the first power supply device is smaller than the endurance of the second power supply device. For example, the volume or capacity of the first power supply device may be reduced. Since the second power supply device serves as the main power supply device of the earphone 100, the first power supply device only needs to maintain the sound-emitting portion 10 to work normally for a period of time when the sound-emitting portion 10 is disconnected from the transition connecting portion 30. Therefore, setting the endurance of the first power supply device to be smaller than the endurance of the second power supply device is conducive to reducing the cost of the earphone 100, furthermore, under the condition that the first power supply device and the second power supply device employ batteries with the same energy density, it is also conducive to reducing the volume of the first power supply device, thereby reducing the volume of the sound-emitting portion 10, and facilitating wearing.

In some embodiments, the first power supply device may also be electrically connected to the power-receiving structure. In this way, when the power-receiving structure is connected to the power-feeding structure 303, the second power supply device can charge the first power supply device. In addition, when the earphone 100 is placed in an earphone box as a whole, the earphone box can also charge the first power supply device.

In some embodiments, when the sound-emitting portion 10 is connected to the transition connecting portion 30, the second power supply device is electrically connected to the speaker unit and the microphone unit. In this way, the second power supply device can directly power the speaker unit and the microphone unit.

It should be noted that when the power-receiving structure is connected to the power-feeding structure 303, at least one of the second power supply device and the first power supply device powers the speaker unit. That is, when the sound-emitting portion 10 and the transition connecting portion 30 are in the connected state, only the first power supply device may power the speaker unit, or only the second power supply device may power the speaker unit, or both the first power supply device and the second power supply device may power the speaker unit.

Optionally, when the power-receiving structure is connected to the power-feeding structure 303, the earphone 100 is configured such that the first power supply device firstly powers the power-consuming components (including the speaker unit, the microphone unit, and the electric control unit) of the sound-emitting portion 10, and when the electricity capacity of the first power supply device is lower than a preset value, it may switch to the second power supply device for powering the power-consuming components of the sound-emitting portion 10, and the second power supply device can power the power-consuming components of the sound-emitting portion 10 directly or through the first power supply device, that is, current of the second power supply device flows through the first power supply device and then flows to the power-consuming components of the sound-emitting portion 10. In this way, the second power supply device can not only charge the first power supply device, but also power the power-consuming components. Moreover, through the cooperation of the first power supply device and the second power supply device, the endurance capability of the earphone 100 can be increased better.

In some embodiments, in conjunction with FIGS. 1 and 2, FIGS. 5-6, and FIGS. 9 and 10, the sound-emitting portion 10 may further include a first housing 101, and the first housing 101 may include a sound-emitting housing 102, a projection of the sound-emitting housing 102 may be of a shape similar to a circle or an ellipse or the like, so that the sound-emitting housing 102 is adapted to be accommodated in a space behind the tragus 202 or the concha cavity 201 of the ear 200.

At least the speaker unit and the microphone unit are disposed in an inner cavity of the sound-emitting housing 102. For example: the speaker unit and the microphone unit may be disposed in the inner cavity of the sound-emitting housing 102; in addition to the speaker unit and the microphone unit, whether any one of the electric control unit and the first power supply device is intended to be disposed in the inner cavity of the sound-emitting housing 102 can be selected according to the space size of the sound-emitting housing 102, which is not limited in the present embodiment.

When the speaker unit and the microphone unit are disposed in the inner cavity of the sound-emitting housing 102, on the one hand, it can ensure that the speaker unit is closer to the ear canal opening, which is conducive to ensuring acoustic effect, and on the other hand, it can ensure that the microphone unit is as close as possible to a front side of the face, so as to improve the pickup effect of sounds emitted by the wearer.

Optionally, a sound outlet region is provided on the sound-emitting housing 102, and a sound outlet is disposed in the sound outlet region, taking the earphone 100 being an ear-clip type of earphone as an example, when the sound-emitting portion 10 and the transition connecting portion 30 are in the connected state, the sound-emitting housing 102 is located in the concha cavity 201, and at least part of the sound outlet region faces the ear canal opening and is spaced apart from the ear canal opening and the tragus by a certain distance; when the sound-emitting portion 10 is disconnected from the transition connecting portion 30, only the sound-emitting portion 10 needs to be rotated by a certain angle, so that the sound-emitting portion 10 can be clamped in the space behind the tragus 202 and block the outside of the ear canal, at this time, at least part of the sound outlet region still faces the ear canal opening, and the sound outlet region is closer to the ear canal opening, which can achieve better sound effect and is conducive to isolating environmental noise.

In some embodiments, in conjunction with FIGS. 1 and 2 and FIGS. 5-6, considering that the volume of the sound-emitting housing 102 is limited, the first housing 101 may further include an electric control housing 103. Specifically, the electric control housing 103 is connected with the sound-emitting housing 102 to together form the first housing 101. At least the electric control unit is disposed in the electric control housing 103, for example, only the electric control unit may be disposed in the electric control housing 103, or both the first power supply device and the electric control unit may be disposed in the electric control housing 103. The electric control housing 103 may be formed into a strip shape matching the length of a circuit board of the electric control unit, of course, it may also be formed into other shapes.

It can be understood that the inner cavity of the electric control housing 103 and the inner cavity of the sound-emitting housing 102 may be in communication, so as to facilitate connection between the electric control unit and the microphone unit and the speaker unit.

By providing the electric control housing 103 for the electric control unit, it is possible to avoid the electric control unit occupying the space of the sound-emitting housing 102 which, otherwise, results in the volume of the sound-emitting housing 102 being too large and not easy to wear. Moreover, providing the electric control housing 103 facilitates making the sound-emitting portion 10 more stably worn on the ear when disconnected from the transition connecting portion 30, by adjusting the shapes of the electric control housing 103 and the sound-emitting housing 102 and their relative position relationship with each other.

In some embodiments, in conjunction with FIGS. 1 and 2 and FIGS. 5-6, the electric control housing 103 is disposed at an angle to the sound-emitting housing 102, specifically, in order to better accommodate the electric control unit, the electric control housing 103 may be configured such that its length direction is substantially parallel to the length direction of the circuit board, since the sound-emitting housing 102 needs to be clamped in the space behind the tragus 202 or the concha cavity 201, the size of the sound-emitting housing 102 is usually larger than the width of the electric control housing 103, thereby making a part of the sound-emitting housing 102 protruding beyond the electric control housing 103 form a certain angle with the electric control housing 103, and the angle may be within the range of 60°-110°. Therefore, on one hand, it avoids the combination body of the electric control housing 103 and the sound-emitting housing 102 being too large, and on the other hand, the electric control housing 103 can cooperate with the sound-emitting housing 102 to improve the stability when the sound-emitting portion 10 is worn alone.

In some embodiments, in conjunction with FIGS. 1 and 2, FIGS. 5-6 and FIGS. 9 and 10, when the sound-emitting portion 10 is connected with the transition connecting portion 30, at least part of the structure of the first housing 101 is mated with the transition connecting portion 30, for example, the sound-emitting housing 102 may be mated with the transition connecting portion 30, or the electric control housing 103 may be mated with the transition connecting portion 30. In this way, the cooperation forms between the sound-emitting portion 10 and the transition connecting portion 30 are various, which can meet more usage requirements.

In some specific embodiments, the electric control housing 103 is mated with the transition connecting portion 30, and the sound-emitting housing 102 is located at one end of the electric control housing 103.

Exemplarily, the electric control housing 103 may be mated with the transition connecting portion 30 in an up-down direction, the electric control housing 103 may be located on an upper side of the transition connecting portion 30, or the electric control housing 103 may be located on a lower side of the transition connecting portion 30.

Alternatively, the electric control housing 103 may be mated with the transition connecting portion 30 in an inward-outward direction, wherein the inward direction refers to a direction toward the human face, and the outward direction refers to a direction away from the human face, the electric control housing 103 may be located on an inner side of the transition connecting portion 30, or the electric control housing 103 may be located on the outer side of the transition connecting portion 30.

Alternatively, the electric control housing 103 may be mated with the transition connecting portion 30 in a front-back direction, for example, the electric control housing 103 is located on a front side of the transition connecting portion 30.

In some embodiments, in conjunction with FIGS. 1 and 2, FIGS. 5-6 and FIGS. 9 and 10, at least part of the structure of the first housing 101 has a mating surface, a part of the surface of the transition connecting portion 30 is formed into a mating cooperation surface 301, the above-described power-receiving structure may be disposed on the mating surface, and the power-feeding structure 303 may be disposed on the mating cooperation surface 301, the mating surface is suitable for abutting with the mating cooperation surface 301, the mating surface is formed into a plane or a curved surface, therefore, when the sound-emitting portion 10 is connected with the transition connecting portion 30, they cooperates with each other stably, preventing misalignment, and the appearance consistency is better.

Alternatively, one end of the transition connecting portion 30 connected with the sound-emitting portion 10 has a balance portion 302, the size of the balance portion 302, such as width, thickness, length, etc., may be greater than the size of the body portion 20 of the transition connecting portion 30, the above-described mating cooperation surface 301 may be constituted by a part of the surface of the balance portion 302. Therefore, for the ear-clip type of earphone 100 or the ear-hook type of earphone 100, after disconnecting the sound-emitting portion 10 from the transition connecting portion 30, the balance portion 302 and the body portion 20 can realize weight balance on the front and back sides of the ear 200, thereby ensuring that a combination of the transition connecting portion 30 and the body portion 20 can also be stably worn on the ear 200.

In some embodiments, in conjunction with FIGS. 4 and 8, when the sound-emitting portion 10 is disconnected from the transition connecting portion 30, the sound-emitting housing 102 is suitable for abutting with the ear canal opening, and the electric control housing 103 is suitable for being clamped between the tragus 202 and the antitragus 203, therefore, through mutual cooperation between the sound-emitting housing 102 and the electric control housing 103, the stability when the sound-emitting portion 10 is worn alone can be improved, and falling off can be prevented.

In some embodiments, the sound-emitting portion 10 and the transition connecting portion 30 are magnetically attached to each other or are snap-fitted to each other. In this way, the connection modes between the sound-emitting portion 10 and the transition connecting portion 30 are various, and they are all convenient for users to connect or disconnect the sound-emitting portion 10 and the transition connecting portion 30.

Taking magnetic attachment between the sound-emitting portion 10 and the transition connecting portion 30 as an example: a first magnetic attachment member may be provided on the first housing 101 of the sound-emitting portion 10, the first magnetic attachment member may be a magnetic coating attached to the first housing 101, or may be a magnetic attachment member fixedly disposed on the first housing 101 via a mechanical connection manner, a second magnetic attachment member is provided on the transition connecting portion 30, the second magnetic attachment member may be a magnetic coating attached to the transition connecting portion 30, or may be a magnetic attachment member fixedly disposed on the transition connecting portion 30 via a mechanical connection manner, the sound-emitting portion 10 and the transition connecting portion 30 achieve magnetic attachment via the first magnetic attachment member and the second magnetic attachment member.

Taking snap-fitting between the sound-emitting portion 10 and the transition connecting portion 30 as an example: a first snap-fit structure may be provided on the first housing 101 of the sound-emitting portion 10, the first snap-fit structure may be a snap hook, a snap pillar, etc., a second snap-fit structure is provided on the transition connecting portion 30, the second snap-fit structure may be a snap groove, a snap hole, etc., the sound-emitting portion 10 and the transition connecting portion 30 achieve snap-fitting via the first snap-fit structure and the second snap-fit structure.

Of course, the present disclosure is not limited to this, and the sound-emitting portion 10 and the transition connecting portion 30 may be connected via other manners, such as plug connection, bonding, etc., which can be reasonably selected according to actual needs.

In some embodiments, the transition connecting portion 30 is suitable for being suspended on an upper side of the ear 200, that is, the earphone 100 in this embodiment may be an ear-hook type of earphone.

In other embodiments, the transition connecting portion 30 is suitable for applying a pre-acting force to the sound-emitting portion 10 and the body portion 20 so that the sound-emitting portion 10 and the body portion 20 jointly clamp the ear 200, that is, the earphone 100 in this embodiment is an ear-clip type of earphone.

Thus, it makes the form and wearing manner of the earphone 100 diverse and can achieve diverse acoustic effects.

The earphone system according to an embodiment of the second aspect of the present application will be described below.

The earphone system of the embodiment may include: an earphone box (not shown in the figure) and the earphone 100 in the above embodiments.

Among them, the earphone box has an accommodation cavity that can be openable and closeable. The earphone 100 is removably disposed in the accommodation cavity, and the earphone box is at least configured to charge the earphone 100.

The earphone system of the embodiment, through arranging the earphone 100 in the above embodiments, can realize multiple acoustic effects and can improve the user's usage experience better, since the earphone 100 has multiple wearing forms.

Embodiments or implementation manners in the specification are described in a progressive manner, each embodiment focuses on a difference from other embodiments, and similar or identical parts between the embodiments can be referred to each other.

It should be pointed out that the embodiments indicated by “an embodiment”, “embodiment”, “exemplary embodiment”, “some embodiments” and the like mentioned in the specification may include specific features, structures or characteristics, but such specific features, structures or characteristics are not necessarily included in each embodiment. In addition, such phrases do not necessarily refer to the same embodiment. In addition, when specific features, structures or characteristics are described in conjunction with embodiments, it is within the knowledge of those skilled in the art to implement such features, structures or characteristics in conjunction with explicitly or implicitly described other embodiments.

Generally speaking, terms should be understood at least partially by their use in context. For example, according to the context, the term “one or more” used herein may be used to describe any feature, structure or characteristic having a singular meaning, or may be used to describe a combination of features, structures or characteristics having a plural meaning. Similarly, according to the context, terms such as “a” or “the” may be understood as conveying a singular usage or conveying a plural usage.

It should be easily understood that “on . . . ”, “above . . . ” and “over. . . ” in the present disclosure should be interpreted in the broadest way so that “on. . . ” not only means “directly on something”, but also includes the meaning of “on something, with an intermediate feature or layer therebetween”, and “above. . . ” or “over. . . ” not only includes the meaning of “above” or “over” something, but also can include the meaning of “above” or “over” something and there is no intermediate feature or layer therebetween (that is, directly on something).

In addition, for convenience of description, spatial relative terms, such as “below”, “under”, “beneath”, “above”, “over”, etc., may be used herein to describe the relationship between one element or feature and another element or feature as shown in the drawings. In addition to the orientation shown in the drawings, spatial relative terms are intended to encompass different orientations of the device in use or operation,. The device may have other orientations (rotated 90 degrees or in other orientations), and the spatially relative descriptive words used herein may be similarly interpreted accordingly.

Finally, it should be stated that: the above embodiments are only used to illustrate, not limit, the technical solutions of the present application; although the present application has been described in detail with reference to the foregoing embodiments, ordinary skilled in the field should understand: the technical solutions recorded in the foregoing embodiments can be modified, or part or all of the technical features therein can be equivalently replaced; and such modifications or replacements do not make the essence of the corresponding technical solutions depart from the scopes of the technical solutions of the embodiments of the present application.

What is claimed is

1. An earphone (100), comprising:
a sound-emitting portion (10), configured to be disposed on a front side of an ear (200);
a body portion (20), configured to be disposed on a rear side of the ear (200); and
a transition connecting portion (30), two ends of the transition connecting portion (30) being respectively connected with the sound-emitting portion (10) and the body portion (20), wherein the sound-emitting portion (10) is detachably connected with the transition connecting portion (30).

2. The earphone (100) of claim 1, wherein the sound-emitting portion (10) comprises a first power supply device and a power-consuming component, the power-consuming component comprising a speaker unit, a microphone unit, and an electric control unit, wherein the electric control unit is respectively connected with the speaker unit, the microphone unit, and the first power supply device.

3. The earphone (100) of claim 2, wherein the electric control unit comprises: a power-receiving structure;
the body portion (20) comprises a second power supply device, wherein one end of the transition connecting portion (30) connected with the sound-emitting portion (10) is provided with a power-feeding structure (303) electrically connected with the power-receiving structure, the power-feeding structure (303) being connected with the second power supply device;
when the sound-emitting portion (10) is connected with the transition connecting portion (30), the power-feeding structure (303) is connected with the power-receiving structure.

4. The earphone (100) of claim 3, wherein an endurance of the first power supply device is smaller than an endurance of the second power supply device.

5. The earphone (100) of claim 3, wherein the first power supply device is further electrically connected with the power-receiving structure, so as to be charged when the power-receiving structure is connected with the power-feeding structure (303).

6. The earphone (100) of claim 3, wherein when the sound-emitting portion (10) is connected with the transition connecting portion (30), the second power supply device supplies power to the power-consuming component.

7. The earphone (100) of claim 3, wherein when the power-receiving structure is connected with the power-feeding structure (303), at least one of the second power supply device and the first power supply device supplies power to the power-consuming component.

8. The earphone (100) of claim 2, wherein the sound-emitting portion (10) further comprises:
a first housing (101), comprising a sound-emitting housing (102), wherein at least the speaker unit and the microphone unit are disposed in an inner cavity of the sound-emitting housing (102).

9. The earphone (100) of claim 8, wherein the first housing (101) further comprises: an electric control housing (103), wherein the electric control housing (103) is connected with the sound-emitting housing (102), wherein at least the electric control unit is disposed in the electric control housing (103).

10. The earphone (100) of claim 9, wherein the electric control housing (103) is arranged at an angle to the sound-emitting housing (102).

11. The earphone (100) of claim 9, wherein when the sound-emitting portion (10) is connected with the transition connecting portion (30), at least part of a structure of the first housing (101) is mated with the transition connecting portion (30).

12. The earphone (100) of claim 11, wherein the electric control housing (103) is mated with the transition connecting portion (30), the sound-emitting housing (102) being located at one end of the electric control housing (103).

13. The earphone (100) of claim 11, wherein the at least part of the structure of the first housing (101) has a mating surface,
wherein a part of a surface of the transition connecting portion (30) is formed into a mating cooperation surface (301),
the mating surface is adapted to abut with the mating cooperation surface (301),
the mating surface is formed into a plane or a curved surface.

14. The earphone (100) of claim 9, wherein when the sound-emitting portion (10) is disconnected from the transition connecting portion (30), the sound-emitting housing (102) is adapted to be arranged to abut with an ear canal opening, the electric control housing (103) being adapted to be sandwiched between an tragus (202) and an antitragus (203).

15. The earphone (100) of claim 1, wherein the sound-emitting portion (10) and the transition connecting portion (30) are in magnetic attachment or snap-fit.

16. The earphone (100) of claim 1, wherein the transition connecting portion (30) is adapted to be suspended on an upper side of the ear (200); or the transition connecting portion (30) is adapted to apply a pre-acting force to the sound-emitting portion (10) and the body portion (20) so that the sound-emitting portion (10) and the body portion (20) jointly clamp the ear (200).

17. An earphone system, wherein it comprises:
an earphone box, having an accommodation cavity that is openable and closable; and
an earphone (100), wherein the earphone (100) is removably disposed in the accommodation cavity, wherein the earphone box is at least configured to charge the earphone (100),
wherein the earphone (100) comprises:
a sound-emitting portion (10), configured to be disposed on a front side of an ear (200);
a body portion (20), configured to be disposed on a rear side of the ear (200); and
a transition connecting portion (30), two ends of the transition connecting portion (30) being respectively connected with the sound-emitting portion (10) and the body portion (20), wherein the sound-emitting portion (10) is detachably connected with the transition connecting portion (30).

18. An earphone system of claim 17, wherein the sound-emitting portion (10) comprises a first power supply device and a power-consuming component, the power-consuming component comprising a speaker unit, a microphone unit, and an electric control unit, wherein the electric control unit is respectively connected with the speaker unit, the microphone unit, and the first power supply device.

19. An earphone system of claim 18, wherein the electric control unit comprises: a power-receiving structure;
the body portion (20) comprises a second power supply device, wherein one end of the transition connecting portion (30) connected with the sound-emitting portion (10) is provided with a power-feeding structure (303) electrically connected with the power-receiving structure, the power-feeding structure (303) being connected with the second power supply device;
when the sound-emitting portion (10) is connected with the transition connecting portion (30), the power-feeding structure (303) is connected with the power-receiving structure.

20. An earphone system of claim 18, wherein the sound-emitting portion (10) further comprises:
a first housing (101), comprising a sound-emitting housing (102), wherein at least the speaker unit and the microphone unit are disposed in an inner cavity of the sound-emitting housing (102).
